(19) United States
(12) Patent Application Publication
(10) Pub. No.: US 2001/0010777 A1
(43) Pub. Date: Aug. 2, 2001

(54) System to make illustrations

(76) Inventor: Edwin R. van der Heide, Rijpwetering (NL)

Correspondence Address: MICHAEL SCHWARZ, 12TH FLOOR, 625 MADISON AVENUE, NEW YORK, NY, 10022, US

(21) Appl. No.: 09/811,892

(22) Filed: Mar. 19, 2001

Related U.S. Application Data
(63) Continuation of application No. PCT/NL99/00573, filed on Sep. 14, 1999.

(30) Foreign Application Priority Data
Sep. 22, 1998 (NL) 1010146

(51) Int. Cl. B43K 5/16

(52) U.S. Cl. 401/99

(57) ABSTRACT

A system to make illustrations has at least one writable sheet of material with a first side and a second side, and at least an ink-producing writing device to write on the sheet of material. The sheet is secured in a thread-shaped frame. Provision is made for attachment devices in order to attach the frame to a vertical surface, such as one or more suckers, which are connected to the sheet of material and the frame. Further, provision is made for a writing material holder and erasers in order to erase an illustration made.

### CROSS REFERENCE TO RELATED APPLICATION

This application is a continuation application of PCT/NL99/00573 filed Sep. 14, 1999.

### FIELD OF THE INVENTION

The invention relates to a system for making illustrations, comprising at least a sheet of writable material having a first side and a second side, and at least an ink-producing writing means for writing on the sheet of material.

### DISCUSSION OF THE PRIOR ART

Such systems are well known, for example in the shape of sheets of transparent material on which can be written and drawn in order to offer presentations with the aid of an overhead projector.

### SUMMARY OF THE INVENTION

The invention aims to provide a system of the above mentioned type, which offers alternative possibilities of use.

To reach this object, the system according to the invention is characterized by a frame in which the sheet of material, such as a foil or film, is mounted, and attaching means for attaching the system of the sheet of material and the frame on a vertical surface.

A first advantageous possibility of use which is being realized in this way, is to enable children on the back seat of a car to make an illustration on the sheet of material, and subsequently to exhibit this illustration by attaching it to a side window of the car. Preferably, in this application the sheet of material is essentially transparent, so as not to obstruct a part of the view of the driver of the car. Thus the activity of drawing is combined with riding along in the car, which leads to a satisfactory situation for both child and the driver of the car, because the child is being entertained in a pleasant way.

Of course, illustrations can also be produced by adults.

A second advantageous possibility of use which is being realized with the system according to this invention, is making illustrations at home and for example in shops, where the sheet of material is being attached to an interior window or to a window on the outer wall. In the latter case the illustration can be viewed by passers-by.

The system according to the invention can be used for example to spread a commercial, political, religious or ideological message from behind a car window, home window or shop window.

With a proper choice of attachment means the system can also be attached to a wall or any other vertical surface.

For some uses the sheet of material can be essentially opaque, and moreover be adapted to be pervious to the ink from the writing means from the first to the second side. In particular the application is being contemplated wherein the attachment means are situated on the second side of the sheet of material, and are adapted to attach the system of sheet of material and frame to a transparent wall, such as a window, through which the illustration is to be viewed.

Preferably the ink is covering to insure a clearly viewable illustration. For many applications it is further required that the ink is removable (from surfaces such as the sheet of material) and/or removable by washing (from clothes and the like) and non-poisonous.

Normally speaking the ink is coming off through a writing point of an oblong writing means, such as in particular a felt-tipped pen and the like. In a preferred embodiment an essentially sleeve-shaped protection member is provided around the writing point, which is movable in the longitudinal direction of the writing means in order to cover the writing point when it is not in contact with the sheet of material. In particular the protection member covers the writing point to reveal at least part of the writing point when this is placed on the sheet of material. This is advantageous in particular in the above mentioned application of the system according to the invention when the writing material is being used by a child in the car, when it is undesirable when the ink of a free writing means is coming off on the interior parts of a car.

In a preferred embodiment the protective member consists of a flexible and elastic material, such as rubber, and simply is designed as a bellows.

For a suitable use the system further comprises a writing means holder, such as a case with an opening flap, to put away the writing means, which writing means holder is provided with holder fixing means, such as a sucker, to attach the case to the earlier mentioned surface.

In another preferred embodiment the system further comprises erasing means, such as a cloth or sponge moistened with a non-poisonous, ink-resolving substance, possibly washable, to remove the ink from the sheet of material.

In a simple, inexpensive and fit for the purpose design, the frame is thread-like. However, the frame can also have an at least partially U-shaped cross-section and grip around an edge of the sheet of material.

In order to place the system of the sheet of material and the frame adjacent to the above mentioned surface, the frame is at least partially provided with one or more projections or ribs, which extend substantially transverse to the surface of the sheet of material, of which projections or ribs the extreme points are intended to rest against the surface. Thus, the sheet of material is being held at a suitable distance from the surface in order to prevent undesired accumulation of moisture between the sheet of material and the surface, thanks to the created ventilation.

When connecting the system of the sheet of material and the frame to a smooth surface, the use of one or more suckers as fixing means is preferred. In that case, advantageously a connection between the sheet of material and/or the frame and each sucker comprises a first, male part and a second, female part, the male part being adapted to be inserted into the female part in order to produce a detachable connection. In this case the sucker(s) can be placed permanently on the surface, by which the assembly of the sheet of material and the frame can be detached from the sucker(s) in order to provide an illustration thereon, and next can be connected again.

The claims and advantages will be more readily appreciated as the same becomes better understood by reference to the following detailed description and considered in connection with the accompanying drawings, in which like reference symbols designate like parts.

### BRIEF DESCRIPTION OF THE DRAWINGS

FIG. 1 shows a sheet of material provided with a frame in perspective.

FIG. 2 shows on an enlarged scale a cross-section according to line II-II of the component of FIG. 1.

FIGS. 3-5 show a part of a cross-section of alternative embodiments.

FIG. 6 shows a part of a cross-section of another embodiment in contact with a surface.

FIGS. 7-8 show attachment means according to the invention in cross-section.

FIGS. 9-10 show partially in cross-section several embodiments of writing means according to the invention.

FIG. 11 shows a writing means holder and erasing means.

### DESCRIPTION OF THE PREFERRED EMBODIMENTS

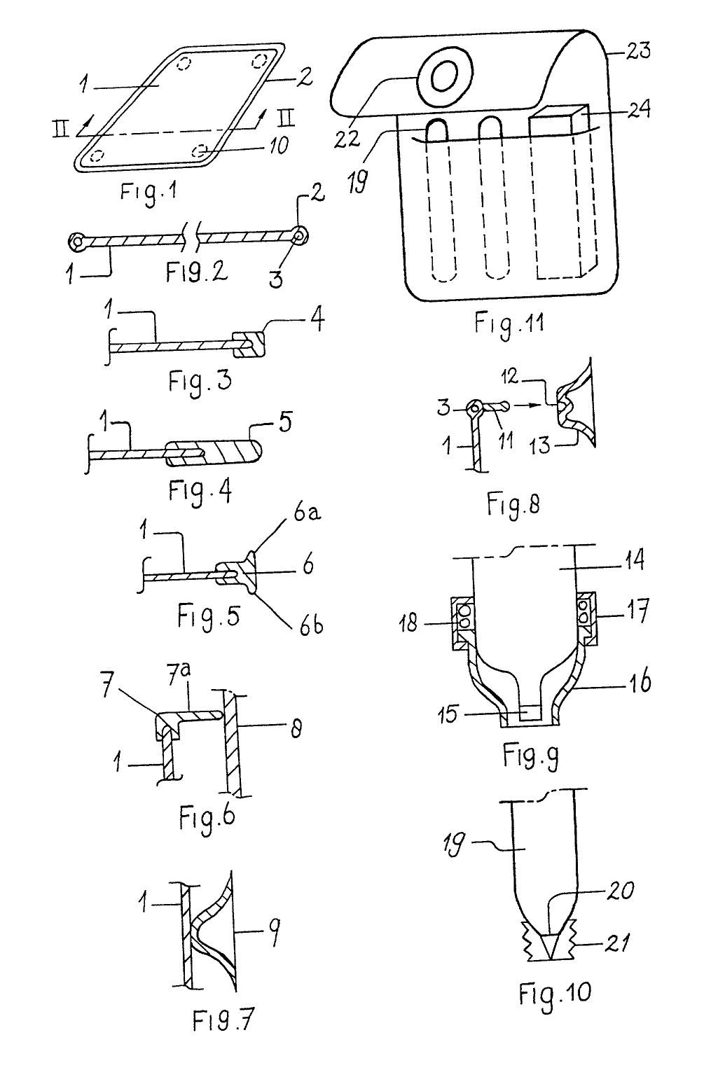

FIGS. 1 and 2 show a sheet of material 1, preferably a transparent synthetic material. The sheet of material 1, which in FIG. 2 for the sake of clarity is represented considerably thicker than it will be in reality, is provided with a frame 2 which, as FIG. 2 shows in detail, comprises a thread-shaped body 3, round which the edge of the sheet of material 1 is applied in a suitable way. The thread-shaped body 3 can be made of metal, and can be connected to the edges of the sheet of material 1 under a pretension, in order to keep the sheet of material under pretension by the thread-shaped body, and thus keep it tight.

The shape of the sheet of material can be chosen as one desires, for example round, rectangular, and the like.

FIG. 3 shows a U-shaped frame 4, made for example of synthetic material, gripping round the edge of the sheet of material 1.

FIG. 4 shows a flat frame 5, made for example of cardboard, in which the edge of the sheet is fixed.

FIG. 5 shows a frame 6 of the type shown in FIG. 3 which is provided with projections or ribs 6a and 6b extending transversely to the plane of the sheet of material 1.

FIG. 6 shows a frame 7 of the type shown in FIG. 3, which is provided with a projection or rib 7a extending transversely to the plane of the sheet of material 1, which projection or rib is intended to rest on a surface of e.g. a wall or a window-pane (like a window 8). The projection or rib 7a ensures that a proper distance is being held between the sheet of material 1 and the surface.

FIG. 7 shows a sheet of material 1 on which a sucker 9 is fixed, for example with the means of glueing or welding. The sucker 9 allows for fixing the sheet of material I on a smooth surface such as a window-pane. In FIG. 1 by means of dotted lines 10 places are indicated where suckers 9 can be fixed to the sheet of material 1. Obviously, it is possible to combine the embodiment according to FIG. 7 with one of the embodiments of the frame shown in FIGS. 2-6.

FIG. 8 shows the embodiment of the frame according to FIG. 2. On the frame a number of projections 11 extending transversely to the plane of the sheet of material 1, each projection being provided with a thickened extremity. The projections 11 are intended to be placed in a hole 12 of a sucker 13, which then can be placed on a smooth surface. The dimensions of the hole 12 are such, that a firm and detachable connection between the frame and the sucker 13 can be obtained. It is also possible to provide similar projections which substantially are directed parallel to the plane of the sheet of material 1 from the frame. Such projections can be accommodated in a hole of a sucker provided at a side thereof. Of course the projection can also be placed on the sucker, the corresponding hole being e.g. provided in the frame.

FIG. 9 shows a felt-tipped pen 14 with a writing point 15. Around the writing point 15 a slidable, substantially sleeve-shaped protection member 16 is provided, of which the end facing away from the writing point 15 end is accommodated in a sleeve 17 fixed to the wall of the felt-tipped pen 14, and is kept under pressure of a spring 18. As a consequence, the protection device 16 normally will cover the writing point 15, such that the ink from the writing point 15 cannot be released in an undesired way. However, as soon as the felt-tipped pen 14 is being placed on a surface, such as a sheet of material 1, the protection member 16 will be pushed away in order to expose a part of the writing point 15, so that the felt-tipped pen can be used in a regular way as writing means.

FIG. 10 shows a felt-tipped pen 19 with a writing point 20 which normally speaking will be covered by a bellows 21, which is made of a flexible and elastic material. When writing with the felttipped pen 19 the bellows will be pushed so far inward, that the writing point comes into contact with the surface to be written on.

FIG. 11 shows a holder 23 for writing means 19, the holder being provided with a sucker 22, and further containing a sponge 24 for erasing an illustration made with a writing means 19 on a sheet of material.

While the invention has been described and illustrated in its preferred embodiments, it should be understood that departures may be made therefrom within the scope of the invention, which is not limited to the details disclosed herein.

What is claimed is:

1. A system to make illustrations, comprising:
at least one writable sheet of material, having a first side and a second side;
at least one ink-delivering writing means for writing on the sheet of material;
a frame in which the sheet of material is mounted;
a plurality of suckers for detachably mounting the assembly of the sheet of material and the frame on a smooth vertical surface, wherein the sheet of material is flexible, and the frame is a thread-shaped body under tension, such as to stretch the sheet of material by the frame.

2. The system of claim 1, wherein the sheet of material essentially is transparent.

3. The system of claim 1, wherein the sheet of material essentially is non-transparent and is also adapted to let the ink of the writing means come off from the first side to the second side.

4. The system of claim 1, wherein the sheet of material is made of synthetic material.

5. The system of claim 1, wherein the ink is covering.

6. The system of claim 1, wherein the ink is removable and/or washable.

7. The system of claim 1, wherein the writing means is a felt-tipped pen.

8. The system of claim 1, wherein the ink is coming off through the writing point of an oblong writing device, and wherein around the writing point an essentially sleeve-shaped protection member is placed, which can be moved in the longitudinal direction of the writing device in order to cover the writing point when it is not in contact with the sheet of material.

9. The system of claim 8, wherein the protection member is situated around the writing point and is adapted to expose at least a part of the writing point, when it is placed on the sheet of material.

10. The system of claim 8, wherein the protection member is made of a flexible and elastic material.

11. The system of claim 10, wherein the protection member is made as a bellows.

12. The system of claim 1, further comprising a writing means holder in order to put away the writing means, which writing means holder is provided with holder attachment means for attaching the writing means holder on said surface.

13. The system of claim 12, wherein the holder attachment means comprise at least one sucker.

14. The system of claim 1, further comprising erasing means for erasing the ink from the sheet of material.

15. The system of claim 14, wherein the erasing means comprise a cloth or sponge.

16. The system of claim 15, wherein the cloth or sponge is moistened with an inkdissolver.

17. The system of claim 1, wherein the frame is essentially U-shaped in cross-section and grips round an edge of the sheet of material.

18. The system of claim 1, wherein the frame at least partially is provided with one or more projections or ribs extending essentially transversely to the plane of the sheet of material.

19. The system of claim 1, wherein a connection between the assembly of the sheet of material and the frame on the one hand and each sucker on the other hand, comprises a first, male part and a second, female part, the male part being adapted to be inserted into the female part in order to form a detachable connection.

20. Writing device for use in the system of claim 1, comprising: at least one writable sheet of material, having a first side and a second side; a frame in which the sheet of material is mounted, wherein the sheet of material is flexible, and the frame is a thread-shaped body under tension, such as to stretch the sheet of material by the frame.
